(19) United States
(12) Patent Application Publication
(10) Pub. No.: US 2005/0245342 A1
(43) Pub. Date: Nov. 3, 2005

(54) Differential carrier assembly

(76) Inventors: Marco Pontanari, Riva del Garde (TN) (IT); Roberto Gianone, Barengo (NO) (IT); Clemente Magnago, Trecate (NO) (IT)

Correspondence Address: CARLSON, GASKEY & OLDS, P.C., 400 WEST MAPLE ROAD, SUITE 350, BIRMINGHAM, MI, 48009, US

(21) Appl. No.: 11/115,962

(22) Filed: Apr. 27, 2005

(30) Foreign Application Priority Data
Apr. 28, 2004 (GB) 0409418.1

(51) Int. Cl. F16H 48/06

(52) U.S. Cl. 475/230

(57) ABSTRACT

A differential carrier assembly includes a differential carrier and a differential casing having a ring gear that is supported on right and left differential bearings for rotation about a differential axis. The right and left differential bearings are each supported in respective right and left bearing housings. A pinion having a pinion gear meshes with the ring gear and includes a spigot positioned on a differential axis side of the pinion gear. The spigot is supported in a spigot bearing, and the spigot bearing is supported in a spigot bearing housing. One of the right or left bearing housings and the spigot bearing housing are formed on a common component which is separate from and securable to the differential carrier.

### REFERENCE TO RELATED APPLICATIONS

This application claims priority to United Kingdom Patent Application GB 0409418.1 filed on Apr. 28, 2004.

### BACKGROUND OF THE INVENTION

The present invention relates to differential carrier assemblies.

Known differential carrier assemblies include several components, the primary components being a differential carrier, an input pinion, a ring gear and a differential casing. Various components are mounted on bearings, and it is important to ensure the correct pre-load on certain bearings during assembly. It is also important to ensure the correct back lash between the ring gear and the input pinion. Thus, it is necessary to ensure that the input pinion is positioned longitudinally (relative to the pinion axis) correctly relative to the ring gear. It is also important to ensure that the ring gear is correctly positioned laterally (relative to the input pinion axis). For these reasons, the correct assembly of a differential carrier is time consuming, complicated, and therefore expensive.

In particular, it is known to have an input pinion having a pinion gear mounted between a pinion shaft and a spigot. The spigot (which is on the differential casing side of the pinion gear) is rotatably mounted in a spigot bearing which in turn is mounted in a spigot bearing housing. The pinion shaft is also mounted in bearings which again are mounted in a pinion shaft bearing housing. The spigot bearing housing and the pinion shaft bearing housing are formed in an integral component and as such the pinion shaft bearing housing must be large enough to allow the pinion gear to pass therethrough during assembly. Such an arrangement is shown in U.S. Pat. No. 5,520,589, GB1545004, GB226717, GB 1247751 and FIG. 2 of U.S. Pat. No. 5,203,750. Such arrangements either require a large internal diameter for the pinion shaft bearing housing and/or the outer diameter of the pinion gear teeth to be machined away (as shown in FIG. 2 of U.S. Pat. No. 5,203,750) to ensure the pinion gear fits through the pinion shaft bearing housing.

Alternatively, the pinion can be assembled into the pinion shaft bearing assembly housing from the differential casing side. Under these circumstances, the diameter of the pinion gear can be larger than the internal diameter of the pinion shaft bearing assembly housing. However, the spigot bearing housing must be provided as a separate component to ensure the components can be assembled. Such an arrangement is shown in U.S. Pat. No. 4,526,063 and FIG. 1 of U.S. Pat. No. 5,203,750. However, in both these embodiments, the pinion shaft bearing assembly housing is integrally formed with the right and left differential bearing housing and hence the differential bearing housings are formed on a separate component to the spigot bearing housing.

### SUMMARY OF THE INVENTION

An object of the present invention is to provide a differential carrier assembly that is easier to assemble. Another object of the present invention is to provide a differential carrier assembly that requires less adjustment to correctly assemble. Another object of the present invention is to provide a differential carrier assembly that is easier to machine.

Thus, according to the present invention, a differential carrier assembly includes a differential carrier having a pinion shaft bearing arrangement housing. A differential casing including a ring gear is supported on right and left differential bearings for rotation about a differential axis. The right and left differential bearings are each supported in respective right and left bearing housings. The differential carrier assembly also includes a pinion having a pinion gear in meshing engagement with the ring gear and a spigot positioned on a differential axis side of the pinion gear. A pinion shaft is positioned on a side of the pinion gear opposite from the spigot. The spigot is supported in a spigot bearing, and the spigot bearing is supported in a spigot bearing housing. The pinion shaft is supported in a pinion shaft bearing arrangement, and the pinion shaft bearing arrangement is supported in the pinion shaft bearing arrangement housing. The spigot bearing housing and one of the right or left bearing housings are formed on a common component which is separate from and securable to the differential carrier.

### BRIEF DESCRIPTION OF THE DRAWINGS

The invention will now be described, by way of example only, with reference to the accompanying drawings in which:

FIG. 1 is an isometric view of an axle assembly including a differential carrier assembly according to the present invention;

FIG. 2 is a plan cross section view of the differential carrier assembly of FIG. 1;

FIG. 3 is a differing view of a differential bearing housing and a pinion spigot bearing housing formed on a common component;

FIG. 4 is a differing view of the differential bearing housing and the pinion spigot bearing housing formed on the common component;

FIG. 5 is a differing view of the differential bearing housing and the pinion spigot bearing housing formed on the common component;

FIG. 6 is a view of a differential bearing housing formed on a separate component; and

FIG. 7 is a view of a differential carrier.

### DETAILED DESCRIPTION OF THE PREFERRED EMBODIMENT

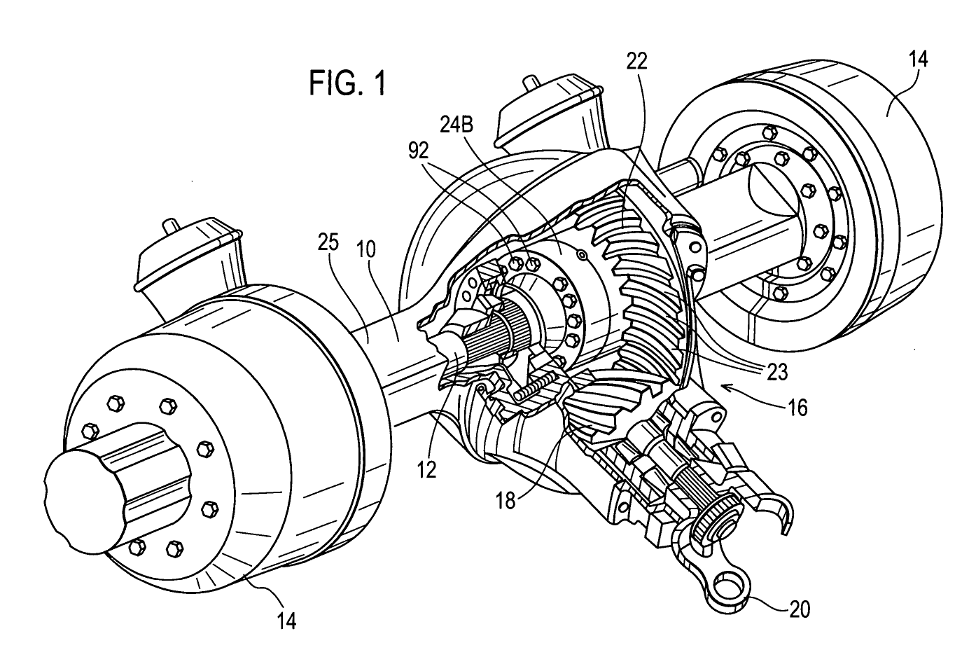

FIG. 1 shows a drive axle 10 which includes a pair of axle shafts 12 (only one of which is shown) for driving wheels (not shown) secured to wheel hubs 14. When the vehicle is driven along a straight path, the wheel hubs 14 turn at approximately the same speed, and the drive torque will be equally split between both wheels. When the vehicle turns, the outer wheel has to travel over a greater distance than the inner wheel. A differential assembly 16 allows the inner wheel to turn more slowly than the outer wheel as the vehicle turns.

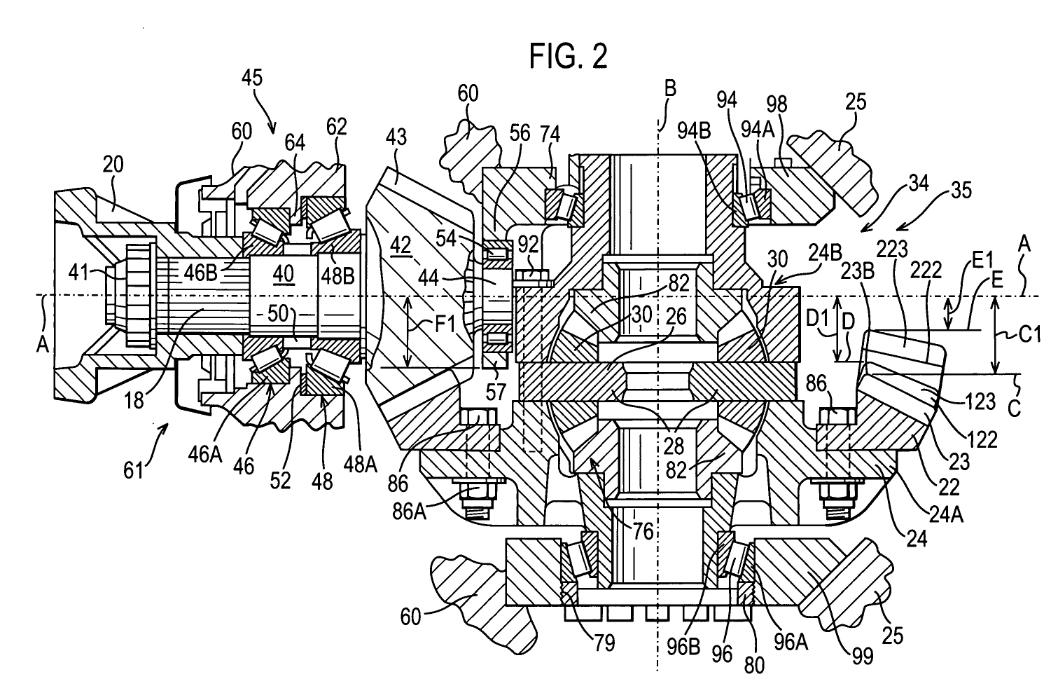

Power is transmitted from an engine and transmission (not shown) to the drive axle 10 via a longitudinally extending drive shaft (not shown). The drive shaft is coupled to an input pinion 18 via a yoke assembly 20. The input pinion 18 is in constant mesh with a differential ring gear 22. As shown in FIG. 2, the differential ring gear 22 is bolted (via bolts 86 and nuts 86A) to a differential casing 24 that turns with the differential ring gear 22.

A differential spider 26 includes four support shafts 28 (only two of which are shown) that are orientated in the shape of a cross. One differential pinion gear 30 is supported for rotation on each support shaft 28. Power is transferred from the differential casing 24 to side gears 82 that are splined to the axle shafts 12. The side gears 82 are in constant mesh with the differential pinion gears 30. The outer ends of the axle shafts 12 are bolted to the wheel hubs 14. An axle housing 25 is used to enclose and protect the differential assembly 16, the gearing and the axle shafts 12. In particular, the axle housing 25 and a differential carrier 60 (see below) completely enclose a common component 70 (see below) and a separate component 76 (see below).

When the vehicle is driven in a straight path, the differential ring gear 22, the differential casing 24, the differential spider 26, the differential pinion gears 30 and the side gears 82 all rotate as one unit to transfer power to the axle shafts 12. There is no relative movement between the differential pinion gears 30 and the side gears 82. When the vehicle turns, the differential pinion gears 30 rotate on their respective support shafts 28 to speed up the rotation of one axle shaft 12 while slowing the rotation of the other axle shaft 12.

FIG. 2 shows the input pinion 18 including a pinion shaft 40, a pinion gear 42 having pinion teeth 43 and a pinion spigot 44. The input pinion 18 is rotatably mounted about a pinion axis A via a pinion shaft bearing arrangement which includes taper roller bearings 46 and 48. Outer races 46A and 48A of the taper roller bearings 46 and 48 are mounted in a housing 62 of a differential carrier 60. A land 64 acts to space apart the outer races 46A and 48A. A spacer 50 spaces apart the inner races 46B and 48B of the taper roller bearings 46 and 48. The pre-load on the taper rolling bearings 46 and 48 can be adjusted by varying a length of the spacer 50 (typically by substituting a different spacer having a different length).

The differential ring gear 22 includes an array of gear teeth 23 and rotates about an axis B (as will be further described below). It is important to set the pinion gear 42 at the correct position relative to the axis B. This can be done by providing thicker or thinner shims 52 positioned between the land 64 and outer race 48A.

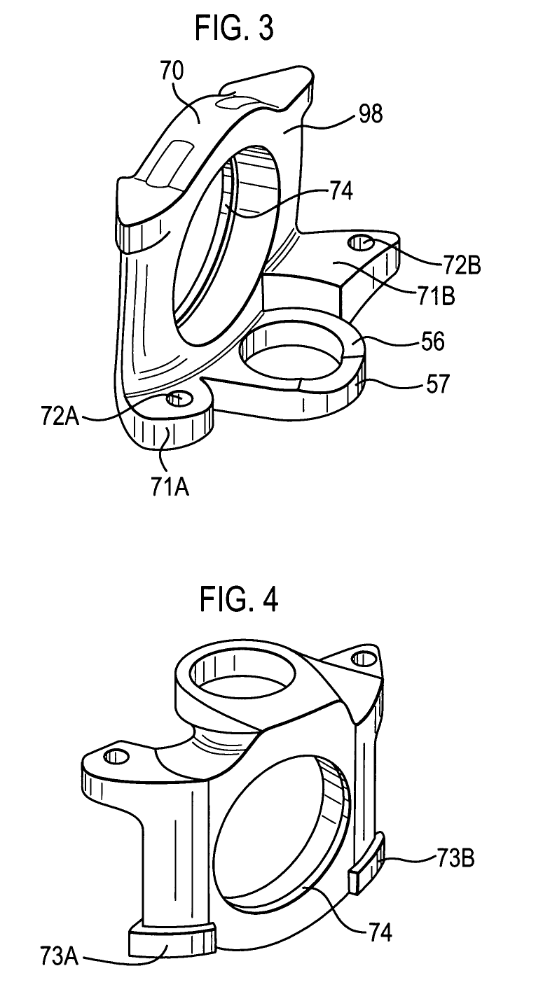

The pinion spigot 44 is supported in a spigot bearing 54, which in turn is mounted in a spigot bearing housing 56 (see in particular FIG. 3).

The differential casing 24 is formed from two halves 24A and 24B which are bolted together via bolts 92. A differential casing sub assembly 34 is provided, the major components of which are the differential casing halves 24A and 24B, the differential ring gear 22, the differential spider 26, the differential pinion gears 30, the bolts 92, the bolts 86 and the associated nuts 86A and the side gears 82.

The differential casing sub assembly 34 is mounted via a right differential bearing 94 and a left differential bearing 96. Each differential bearing 94 and 96 includes a differential bearing outer race 94A and 96A mounted in respective right and left differential bearing housings 98 and 99. Differential bearing inner races 94B and 96B are mounted on projections of differential casing halves 24B and 24A, respectively.

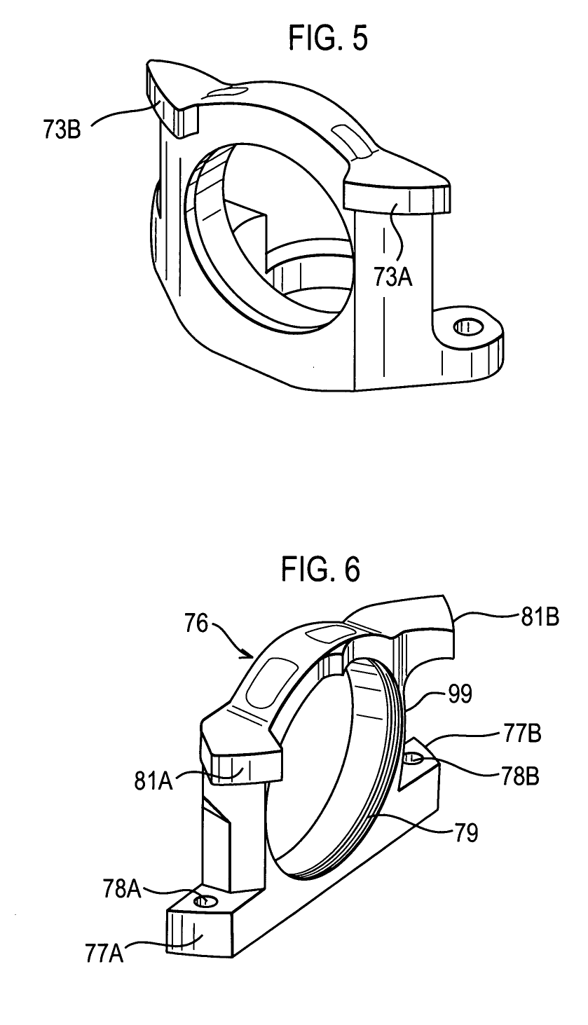

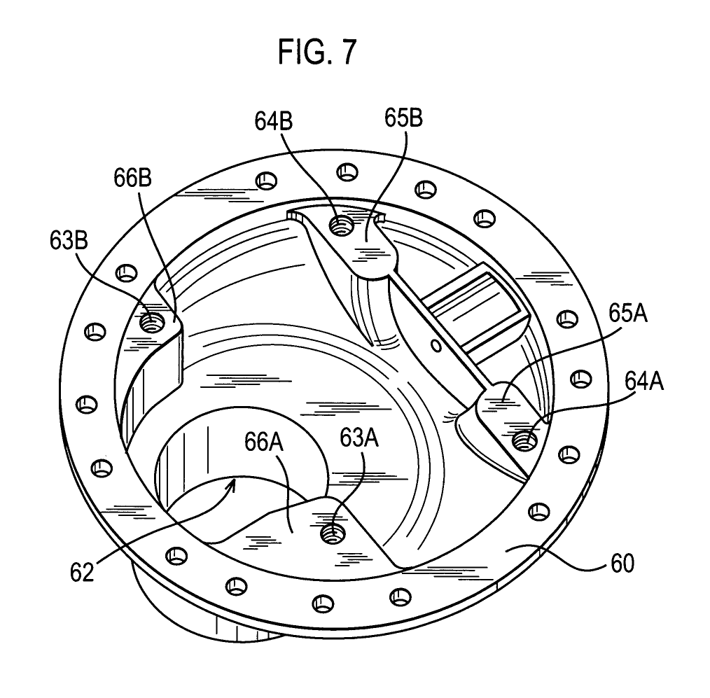

FIGS. 3 to 5 show the right hand differential bearing housing 98 and the spigot bearing housing 56 which have been combined onto a common component 70. In this case, the common component 70 has been formed as a unitary component and furthermore has been machined from a single casting. The common component 70 includes lugs 71A and 71B having holes 72A and 72B through which bolts (not shown) can pass and engage with threaded holes 63A and 63B of the differential carrier 60, thereby securing the common component 70 to the differential carrier 60.

The common component 70 further includes centering abutment surfaces 73A and 73B which engage with corresponding abutment surfaces (not shown) of the axle housing 25 to help center the differential carrier 60 relative to the axle housing 25. The common component 70 further includes a bearing race shoulder 74 (best seen in FIG. 2), the purpose of which will be described below.

FIG. 6 shows the left differential bearing housing 99 which has been formed as a separate component 76. The separate component 76 includes lugs 77A and 77B having through holes 78A and 78B through which bolts (not shown) can pass and engage with threaded holes 64A and 64B of the differential carriers 60, thereby securing the separate component 76 to the differential carrier 60. Centering abutment surfaces 81A and 81B engage corresponding centering abutment surfaces (not shown) of the axle housing 25 to help center the differential carrier 60 relative to the axle housing 25. The separate component 76 includes a threaded region 79 (only part of which is shown in FIG. 6 for clarity). An externally threaded bearing pre-load ring 80 threadingly engages the threaded region 79, and will be further described below.

Regions 65A and 65B of the differential carrier 60 that surround the holes 64A and 64B are flat and lie in a common plane. This provides a flat surface against which abutment surfaces of the lugs 77A and 77B can engage. Similarly, regions 66A and 66B that surround the threaded holes 63A and 63B are also flat and lie in a common plane (though not necessarily common with the plane defined by the regions 65A and 65B) to define abutment surfaces against which corresponding abutment surfaces of the lugs 71A and 71B can engage.

One method of assembling a differential carrier assembly is as follows. The input pinion 18, the taper roller bearings 46 and 48, the spacer 50, the shim 52 and the yoke assembly 20 can all be assembled into the differential carrier 60, and the pinion nut 41 can be tightened such that the pinion bearing pre-load is correct and the axial position of the pinion gear 42 is correct. This provides a differential carrier and pinion sub assembly 61.

Separately, the differential casing sub assembly 34, as described above, can be assembled. The differential bearing inner races 94B and 96B can be mounted on appropriate differential casing halves 24A and 24B, and the differential bearing outer races 94A and 96B can be mounted in the appropriate common component 70 and the separate component 76.

The right differential bearing outer race 94A is assembled such that it engages the bearing race shoulder 74, and the bearing pre-load ring 80 is loosely assembled into the threaded region 79. The spigot bearing 54 is mounted in the spigot bearing housing 56 of the common component 70.

The common component 70 and the separate component 76 can then be loosely assembled onto the differential casing sub assembly 34 to provide a differential casing and bearing housing sub assembly 35 and can then be mounted onto the differential carrier 60. During the mounting of the differential casing and bearing housing sub assembly 35, the pinion spigot 44 will engage the inner race of the spigot bearing 54 at substantially the same time as the gear teeth 23 of the differential ring gear 22 mesh with the pinion gear teeth 43. Bolts can then pass through the holes 72A, 72B, 78A and 78B and into the respective threaded holes in the differential carrier 60 to releasably secure the common component 70 and the separate component 76 to the differential carrier 60, thereby securing the differential casing and bearing housing sub assembly 35. Once this has been done, the bearing pre-load ring 80 can be tightened to set the correct pre-load in the differential bearings 94 and 96.

Prior art differential carrier assemblies have each differential bearing housing formed as two parts. One part is formed integrally with the differential carrier, and the other part is formed as a half cap. This requires machining of the integral part of the bearing housing, separate machining of the half cap, the mating together of the half cap onto the integral part of the bearing housing, and then subsequent finish machining. Since the differential bearing housings of the present invention are not formed in two halves, the machining of these components is simplified.

Prior art differential carrier assemblies also include a spigot bearing that is integral with the differential carrier casting. This requires the carrier casting to be machined with undercuts and other complex machining operations. The machining of the spigot bearing of the present invention can be performed separately from the machining of the differential carrier. Therefore, the machining of the differential carrier is significantly simplified, as is the machining of the spigot bearing housing.

Because the spigot bearing housing 56 and the differential bearing housing 98 can be machined on the common component 70 of the present invention, the manufacturing tolerances between these two components is significantly reduced. The tolerances are such that the fixed bearing race shoulder 74 can be provided on the common component 70, and a single bearing pre-load ring 80 can be provided on the separate component 76. This simplifies assembly since, in the prior art, each differential bearing had its own associated bearing pre-load ring to enable the differential casing to be positioned at the correct lateral position relative to the pinion gear.

The differential ring gear 22 and the input pinion 18 perform two functions. First, they rotate the drive through 90 degrees, i.e., while the input pinion 18 rotates about the axis A, the differential ring gear 22 rotates about the axis B, which is at 90 degrees relative to the axis A. Second, they provide a gear reduction, i.e., the differential ring gear 22 rotates more slowly than the input pinion 18.

Depending upon the particular application, different gear reductions are required, and this can typically be achieved by providing a different input pinion 18 and differential ring gear 22 set. FIG. 2 shows the profiles of three different differential ring gears (22, 122 and 222). The gear teeth 23 of the differential ring gear 22 each have a tooth apex 23B. The set of tooth apexes 23B together define a plane C which is spaced by a distance Cl from the axis A.

The apexes of the gear teeth 23 of the ring gear 122 define a plane D which is spaced by a distance D1 from the axis A, and similarly, the apexes of the teeth of the ring gear 222 define a plane E which is spaced by a distance El from the axis A.

FIGS. 2 and 3 show that the spigot bearing housing 56 has a region 57 which is remote from the axis A. The outer edge of the region 57 is spaced by a distance F1 from the axis A. As shown in FIG. 2, the distance F1 is greater than the distances E1 and D1.

Differential carrier assemblies are known wherein the equivalent distance E1 is less than the equivalent distance F1 and wherein the spigot bearing housing is integral with the differential carrier. Thus, to assemble the differential casing sub assembly, it is necessary to position the differential casing sub assembly to the left relative to its final position as the ring gear tooth apexes pass the spigot bearing housing, and then move the differential casing sub assembly to the right to mesh the ring gear with the pinion gear so that the differential casing sub assembly sits in its correct final position. This requires awkward maneuvering of the components during assembly and also requires a clear space envelope to accommodate such maneuvering.

During the above mentioned assembly process of the present invention, it is possible to position the spigot bearing housing 56 in the annular recess that is immediately radially inboard of the ring gear teeth 23 when the common component 70 is loosely assembled onto the differential casing sub assembly 34 when the differential casing and bearing housing sub assembly 35 is formed. By carrying out this operation remote from the differential carrier 60, no awkward maneuvering of the differential casing and bearing housing sub assembly 35 relative to the differential carrier 60 and the pinion sub assembly 61 is required at a later stage, thereby simplifying assembly and minimizing the clear space envelope requirement.

An alternative way of assembling the differential carrier 60 is to mount the spigot bearing 54 on the pinion spigot 44 first, and then the outer race of the spigot bearing 54 will engage with the spigot bearing housing 56 as the differential casing and bearing housing sub assembly 35 is mated with the pinion sub assembly 61.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A differential carrier assembly comprising:
a differential carrier including a pinion shaft bearing arrangement housing;
a differential casing including a ring gear and supported on a right differential bearing and a left differential bearing for rotation about a differential axis, wherein the right differential bearing and the left differential bearing are supported in a right bearing housing and a left bearing housing, respectively; and
a pinion including a pinion gear in meshing engagement with the ring gear, a spigot positioned on a differential axis side of the pinion gear, and a pinion shaft positioned on an opposite side of the pinion gear from the spigot, wherein the spigot is supported in a spigot bearing that is supported in a spigot bearing housing, and the pinion shaft is supported in a pinion shaft bearing arrangement that is supported in the pinion shaft bearing arrangement housing,
wherein the spigot bearing housing and one of the right bearing housing and the left bearing housing are formed on a common component which is separate from and securable to the differential carrier.

2. The differential carrier assembly as defined in claim 1 wherein the common component is formed as a unitary component.

3. The differential carrier assembly as defined in claim 2 wherein the common component is formed from a casting.

4. The differential carrier assembly as defined in claim 1 wherein the other of the right bearing housing and the left bearing housing is formed as a separate component which is securable to the differential carrier.

5. The differential carrier assembly as defined in claim 4 wherein the separate component is securable to the differential carrier by lugs.

6. The differential carrier assembly as defined in claim 1 wherein the common component includes lugs to secure the common component to the differential carrier.

7. The differential carrier assembly as defined in claim 1 wherein the common component includes a fixed bearing race shoulder, and an outer race of an associated differential bearing abuts the fixed bearing race shoulder.

8. The differential carrier assembly as defined in claim 1 wherein the spigot bearing defines a pinion axis about which the pinion rotates, the ring gear is mounted on one side of the pinion axis and includes an array of teeth each having an apex that define a tooth apex plane, the spigot bearing housing having a region on the one side of the pinion axis, wherein the region of the spigot bearing housing is spaced further from the pinion axis than the tooth apex plane.

9. A method of assembling a differential carrier assembly including steps of
supporting a differential casing including a ring gear on a right differential bearing and a left differential bearing;
supporting the right differential bearing and the left differential bearing in a right bearing housing and a left bearing housing, respectively;
rotatably mounting a pinion including a pinion shaft, a spigot, and a pinion gear located between the pinion shaft and the spigot in a differential carrier including a pinion shaft bearing arrangement housing via a pinion shaft bearing arrangement;
mounting a spigot bearing on or in one of the spigot and a spigot bearing housing;
forming the spigot bearing housing and one of the right bearing housing and the left bearing housing on a common component which is separate from and securable to the differential carrier;
mounting the differential casing on the differential carrier;
meshing the ring gear with the pinion gear; and
mounting the spigot bearing on or in the other of the spigot and the spigot bearing housing; and
securing the common component to the differential carrier.

10. The method of as defined in claim 9 wherein the steps of supporting the differential casing and supporting the right differential bearing and the left differential bearing are carried out remotely from the differential carrier.

11. The method as defined in claim 9 wherein the spigot bearing defines a pinion axis about which the pinion rotates, the ring gear is mounted on one side of the pinion axis and the ring gear includes an array of teeth each having an apex defining a tooth apex plane, wherein a region of the spigot bearing housing on the one side of the pinion axis is spaced further from the pinion axis than the tooth apex plane.

12. The method as defined in claim 9 wherein the step of mounting the differential casing is carried out at substantially the same time as the step of mounting the spigot bearing.

13. The method as defined in claim 9 including the steps of providing the other of the right bearing housing and the left bearing housing as a separate component and securing the separate component to the differential carrier.

14. The method as defined in claim 13 wherein the common component includes a bearing race shoulder, the separate component includes a threaded portion, and a bearing preload ring has a ring thread that engages a thread in the threaded portion, the method further including the step of adjusting the bearing preload ring to provide a correct preload in the right differential bearing and the left differential bearing between the bearing preload ring and the bearing race shoulder.

15. The method as defined in claim 9 wherein the step of rotatably mounting is carried out before the step of securing.

16. The method as defined in claim 9 wherein the step of rotatably mounting includes inserting the pinion shaft into the pinion shaft bearing assembly housing from a differential casing side of the pinion shaft bearing assembly housing.
